(19) United States
(12) Patent Application Publication
(10) Pub. No.: US 2005/0098011 A1
(43) Pub. Date: May 12, 2005

(54) Circular saw with a sawing path indicating device

(75) Inventors: Mei-Lan Kao, Taichung Hsien (TW); Ren-Teng Sie, Taichung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: P & F BROTHER INDUSTRIAL CORPORATION, Taichung (TW)

(21) Appl. No.: 10/985,290

(22) Filed: Nov. 10, 2004

(30) Foreign Application Priority Data
Jun. 26, 2003 (TW) 092211690

(51) Int. Cl. B27B 5/18

(52) U.S. Cl. 83/490; 83/520; 83/471.3

(57) ABSTRACT

A sawing path indicating circular saw includes a circular saw blade rotatably mounted on a saw blade shaft about a blade axis and having left and right major surfaces and a blade edge periphery, a seat member disposed on the saw blade shaft adjacent to the left major surface and rotated with the saw blade shaft, and an illuminating unit disposed on the seat member. Light emitted from the illuminating unit is directed radially and outwardly to project on a light reflecting area of the blade edge periphery and is reflected by the left major surface so as to create a bright region and a dim region on a surface of a workpiece, thereby forming a sharp demarcation line to indicate a sawing path of the saw blade.

### BACKGROUND OF THE INVENTION

1. Field of the Invention

This invention relates to a circular saw, more particularly to a circular saw with a sawing path indicating device that can form a precise demarcation line on a workpiece and that can illuminate a sawing area.

2. Description of the Related Art

Referring to FIG. 1, a conventional circular saw 10 is shown to include a work table 11 for supporting a workpiece 100, a blade supporting frame 12 pivotally mounted on a rear end of the worktable 11 to be moved close to the worktable 11 in a sawing operation, a guard plate 15 for guarding the workpiece 100, a hood 14 pivotally mounted on the blade supporting frame 12 for shielding a circular saw blade 13 and coupled with a linking arm 16 which is operable to lift the hood 14 to thereby expose the saw blade 13 in the sawing operation, and a sawing path indicating device 17 mounted on an axle of the saw blade 13. With reference to FIG. 2, the sawing path indicating device 17 includes a disk 171 and a seat shell 172 coupled to each other. The disk 171 is attached to the saw blade 13, and has an opening 1711 formed in an outer circumferential wall thereof. A laser light source 173 is disposed in the seat shell 172 and is operable to emit a laser beam through the opening 1711 so as to form an indicating line on the workpiece 100 when the sawing path indicating device 17 is rotated with the saw blade 13 during the sawing operation. However, laser light is harmful to the operator due to its high light intensity. Moreover, since the indicating device 17 is distant from the saw blade 13, the indicating line projected on the workpiece 100 cannot precisely indicate the path along which the workpiece 100 is to be sawn. Furthermore, the laser light is not sufficient for illumination purposes.

### SUMMARY OF THE INVENTION

The object of the present invention is to provide a circular saw with a sawing path indicating device that can form a precise demarcation line on a workpiece and that can illuminate a sawing area.

According to this invention, the circular saw includes a blade supporting member, a saw blade shaft mounted on and rotatable relative to the blade supporting member about a blade axis, a circular saw blade mounted on and rotated with the saw blade shaft, and having left and right major surfaces opposite to each other along the blade axis, and a blade edge periphery which interconnects the left and right major surfaces and which is adapted to be brought towards a surface of a workpiece, a seat member disposed on the saw blade shaft adjacent to the left major surface, and rotated with the saw blade shaft about the blade axis, and an illuminating unit disposed on the seat member. Light beam emitted from the illuminating unit is directed radially and outwardly to project on a light reflecting area of the blade edge periphery and is reflected by the left major surface such that, during rotation of the blade edge periphery, a bright region and a dim region which is a shadow cast by the sawing blade are formed on the surface of the workpiece, thereby creating a sharp demarcation line between the bright and dim regions. The demarcation line corresponds to the position of the blade edge periphery on the workpiece in a sawing operation, and indicates a sawing path for the saw blade.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic side view of a conventional sawing path indicating circular saw;

FIG. 2 is a perspective view of a sawing path indicating device of the conventional circular saw;

FIG. 3 is a fragmentary perspective view of the preferred embodiment of a sawing path indicating circular saw according to this invention;

FIG. 4 is a perspective view of a sawing path indicating device of the preferred embodiment;

FIG. 5 is an exploded perspective view of the sawing path indicating device of the preferred embodiment;

FIG. 6 is a side view of the sawing path indicating device of the preferred embodiment;

FIG. 7 is a sectional view of the sawing path indicating device taken along lines I-I of FIG. 6; and

FIG. 8 is a sectional view of the sawing path indicating device taken along lines II-II of FIG. 6.

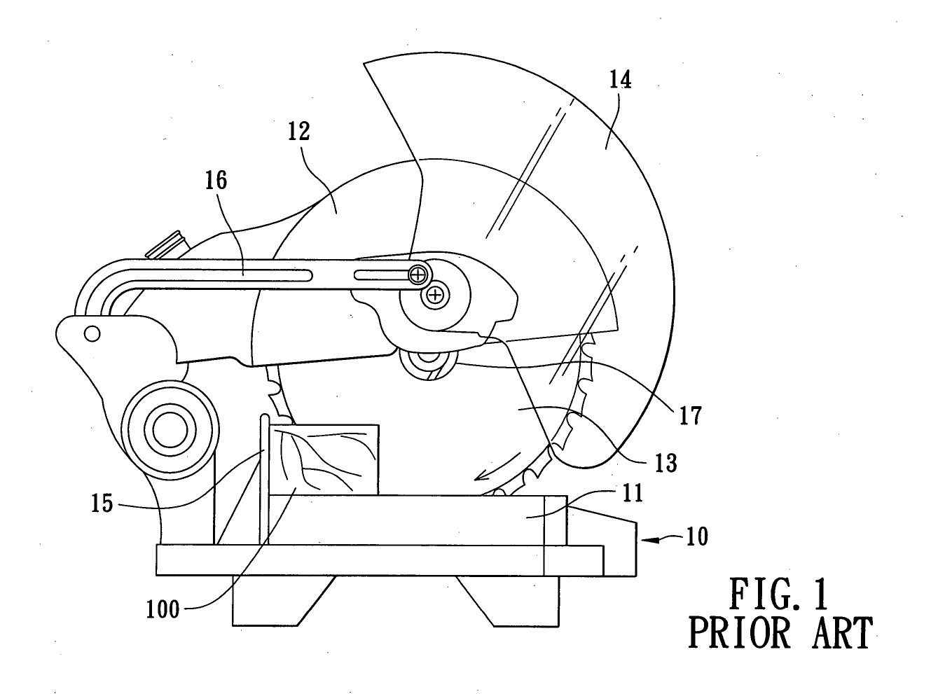

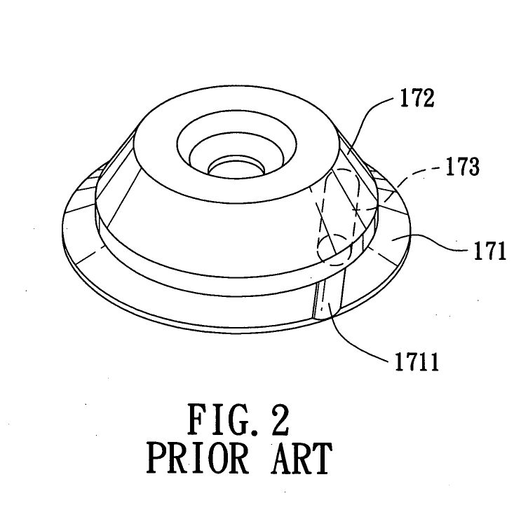

### DETAILED DESCRIPTION OF THE PREFERRED EMBODIMENT

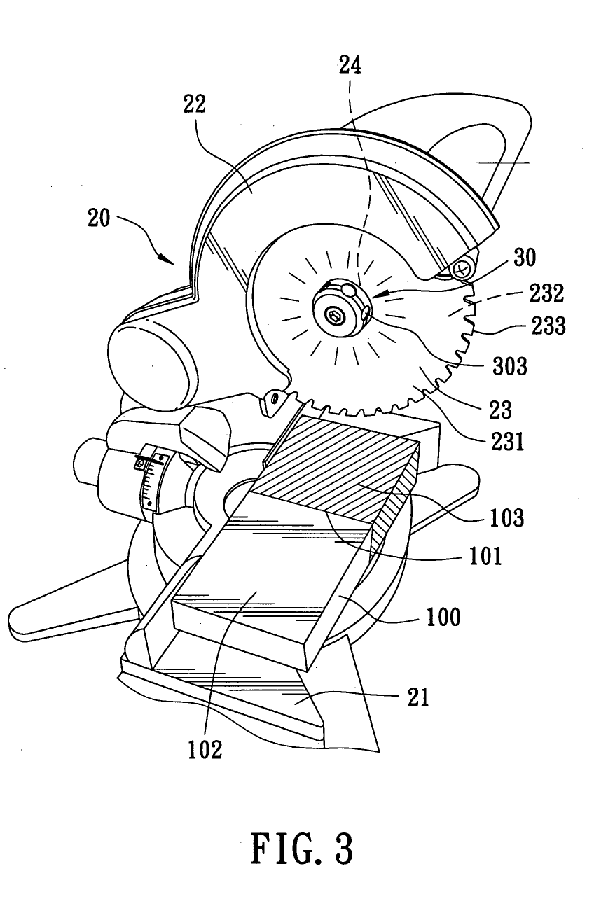

Referring to FIG. 3, the preferred embodiment of a sawing path indicating circular saw 20 according to the present invention is shown to comprise a blade supporting member 22 movably mounted on a worktable 21, a saw blade shaft 24 mounted on and rotatable relative to the blade supporting member 22 about a blade axis, a circular saw blade 23 mounted on and rotated with the saw blade shaft 24, and a sawing path indicating device 30. The saw blade 23 has left and right major surfaces 231, 232 opposite to each other along the blade axis, and a blade edge periphery 233 which interconnects the left and right major surfaces 231, 232 and which is adapted to be brought towards a surface of a workpiece 100 placed on the worktable 21. The circular saw 20 of this invention is generally similar to the conventional circular saw in construction.

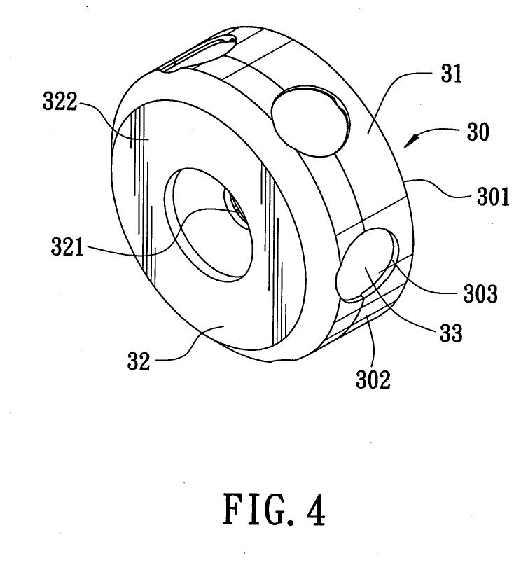

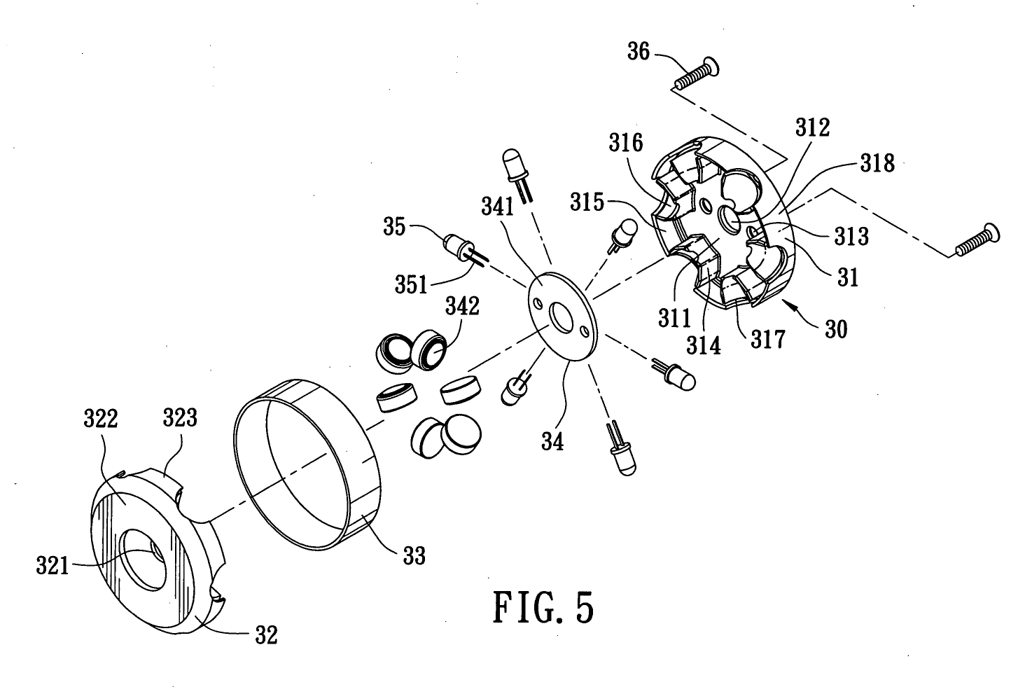

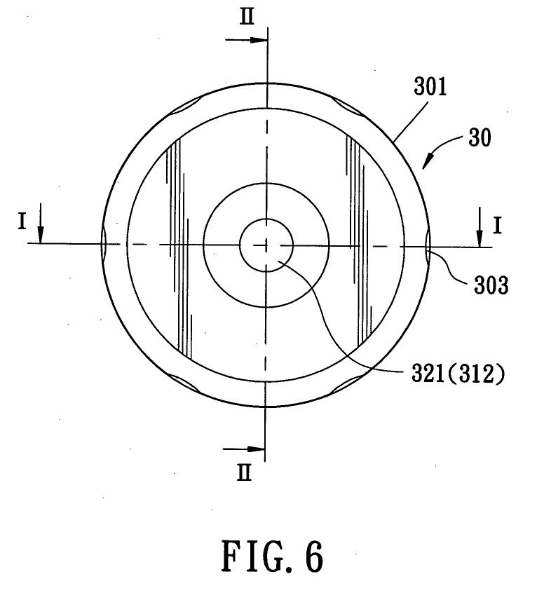

With further reference to FIGS. 4 to 6, this invention is mainly characterized in that the sawing path indicating device 30 includes a body 301 composed of a seat member 31 and a protective shell 32, a circular transparent shield 33, an illuminating unit including a plurality of LED lamps 35, and a circuit unit 34.

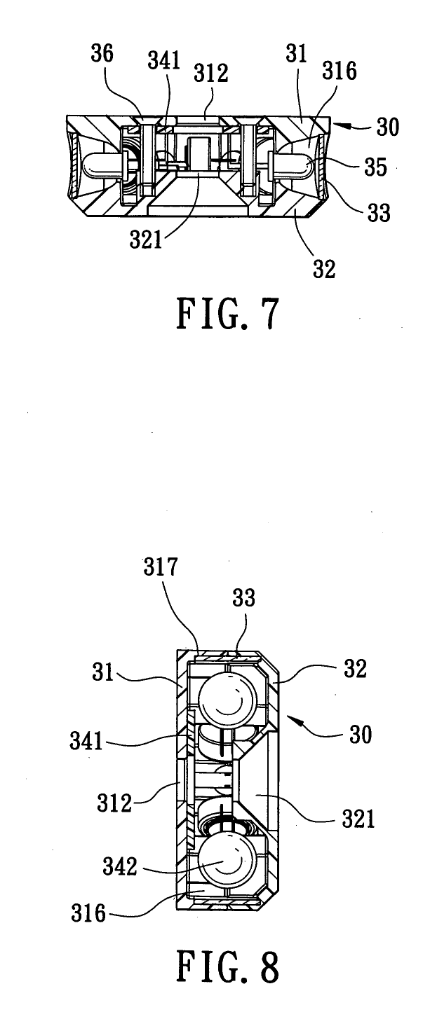

The seat member 31 is disposed on the saw blade shaft 24 adjacent to the left major surface 231 of the saw blade 23, and is rotated with the saw blade shaft 24 about the blade axis. The seat member 31 includes a seat portion 311 formed with an axial hole 312 for passage of the saw blade shaft 24 therethrough such that the seat member 31 is secured on the saw blade shaft 24. Furthermore, the seat member 31 has a periphery, and a peripheral wall 318 which extends from the periphery in an axial direction parallel to the blade axis of the saw blade shaft 24. A plurality of annular grooves 317 are formed in the peripheral wall 318. The protective shell 32 includes a major wall 322 formed with an axial hole 321 that is aligned with the axial hole 312 along the blade axis, and a projecting edge 323 which surrounds the major wall 322 and which is coupled to the peripheral wall 318 by means of screw fasteners 36 so as to cooperatively form a rim portion 302 with the peripheral wall 318. The rim portion 302 surrounds the blade axis so as to confine an accommodation chamber between the major wall 322 and the seat portion 311, and has a plurality of light penetrating regions in form of circular through openings 303 which extend therethrough to be communicated with the accommodation chamber and which are angularly displaced from one another about the blade axis. A plurality of rib plates 314 are formed on the seat portion 311 to partition the accommodation chamber into a plurality of battery seats 315 for mounting a plurality of batteries 342 of the circuit unit 34 and a plurality of lamp seats 316 for mounting the LED lamps 35, as shown in FIGS. 7 and 8. The lamp seats 316 are radially aligned with the through openings 303, respectively.

The circuit unit 34 includes a circuit board 341 which is mounted in the accommodation chamber, and which is electrically connected to the batteries 342 and terminals 351 of the LED lamps 35, thereby permitting supply of electricity to the LED lamps 35.

The transparent shield 33 has a predetermined color, and has a peripheral edge mounted in the annular grooves 317 so as to cover the through openings 303.

In operation, light emitted from the LED lamps 35 is directed radially and outwardly through the through openings 303 to project on a light reflecting area of the blade edge periphery 233 of the saw blade 23 and is reflected by the left major surface 231 of the saw blade 23. Thus, during rotation of the saw blade 23, a bright region 102 and a dim region 103 which is a shadow cast by the sawing blade 23 are formed on the surface of the workpiece 100, thereby creating a sharp demarcation line 101 between the bright and dim regions 102, 103. The demarcation line 101 corresponds to the position of the blade edge periphery 233 on the work piece 100 in a sawing operation, and indicates a sawing path for the saw blade 23.

According to this invention, the LED lamps 35 can emit soft and bright light that is not harmful to the operator, and that enables the forming of a sharp demarcation line 101 on the workpiece 100 to precisely indicate a sawing path of the saw blade 23. Moreover, the LED lamps 35 can illuminate.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A circular saw comprising:
a blade supporting member;
a saw blade shaft mounted on and rotatable relative to said blade supporting member about a blade axis;
a circular saw blade mounted on and rotated with said saw blade shaft, and having left and right major surfaces opposite to each other along the blade axis, and a blade edge periphery which interconnects said left and right major surfaces and which is adapted to be brought towards a surface of a workpiece;
a seat member disposed on said saw blade shaft adjacent to said left major surface, and rotated with said saw blade shaft about the blade axis; and
an illuminating unit disposed on said seat member such that light emitted therefrom is directed radially and outwardly to project on a light reflecting area of said blade edge periphery and is reflected by said left major surface such that, during rotation of said blade edge periphery, a bright region and a dim region which is a shadow cast by said saw blade are formed on the surface of the workpiece, thereby creating a sharp demarcation line between said bright and dim regions, said demarcation line corresponding to position of said blade edge periphery on the workpiece in a sawing operation, and indicating a sawing path of said saw blade.

2. The circular saw of claim 1, wherein said seat member includes a seat portion which is mounted securely on said saw blade shaft and which has a periphery, and a peripheral wall which extends from said periphery in an axial direction parallel to the blade axis,
said circular saw further comprising a protective shell which includes a major wall and a projecting edge surrounding said major wall and coupled to said peripheral wall so as to cooperatively form a rim portion with said peripheral wall, said rim portion surrounding the blade axis so as to confine an accommodation chamber between said major wall and said seat portion, and having a plurality of light penetrating regions which are angularly displaced from one another about the blade axis,
said illuminating unit being received in said accommodation chamber and being securely mounted on said seat portion such that light emitted therefrom are directed radially and outwardly through said light penetrating regions.

3. The circular saw of claim 2, further comprising a circuit unit which is received in said accommodation chamber and which is electrically connected to said illuminating unit for supplying electricity to said illuminating unit.

4. The circular saw of claim 3, wherein said illuminating unit including a plurality of LED lamps which are respectively and radially aligned with said light penetrating regions.

5. The circular saw of claim 2, wherein said light penetrating regions are formed as a plurality of through openings which extend through said rim portion, said circular saw further comprising a transparent shield which is disposed to cover said through openings.
